(19) United States
(12) Patent Application Publication
(10) Pub. No.: US 2007/0291134 A1
(43) Pub. Date: Dec. 20, 2007

(54) Image editing method and apparatus

(75) Inventors: Eui-hyeon Hwang, Goyang-si (KR); Jin-guk Jeong, Yongin-si (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRONICS CO., LTD, Suwon-si (KR)

(21) Appl. No.: 11/802,070

(22) Filed: May 18, 2007

(30) Foreign Application Priority Data
Jun. 19, 2006 (KR) 10-2006-0055132

(51) Int. Cl. H04N 5/225; H04N 5/76

(52) U.S. Cl. 348/231.2; 348/207.99

(57) ABSTRACT

Provided is an image editing apparatus and method. The image editing apparatus includes a containing region determination unit determining a plurality of containing regions from a frame image transmitted from a contents providing device based on first mapping information that maps the containing regions corresponding to a contents genre, a storage unit storing the containing regions determined by the containing region determination unit, and a containing region composition unit reading a main containing region and a sub containing region that are selected from among the containing regions determined by the containing region determination unit from the storage unit, composing the read main containing region and sub containing region, and providing an edited frame image resulting from the composition result.

### CROSS-REFERENCE TO RELATED PATENT APPLICATION

This application claims the benefit of Korean Patent Application No.10-2006-0055132, filed on Jun. 19, 2006, in the Korean Intellectual Property Office, the disclosure of which is incorporated herein in its entirety by reference.

### BACKGROUND OF THE INVENTION

1. Field of the Invention

The present invention relates to image editing, and more particularly, to an image editing apparatus and method to generate an edited image by composing a plurality of containing regions included in a single frame image.

2. Description of the Related Art

Recently, there has been increasing interest in watching moving pictures provided by location-free broadcasting or digital multimedia broadcasting (DMB) using a mobile device. However, considering a physical pixel size that can be perceived by a human, the mobile device cannot display images at resolutions that are equivalent to a high-definition (HD) level. Moreover, when a form factor is small like in a cellular phone, the resolutions of displayed images are only about half of the resolutions of images displayed on general TVs.

When a user watches a sports moving picture using a mobile device, the size of a scoreboard is reduced and players appear to be small because they are viewed remotely, resulting in resolution degradation and physical form factor reduction and thus causing degradation of watching quality. To solve these problems, separate contents for mobile environments are used or the size of an image is mechanically adjusted to be suited for the screen of a mobile device.

U.S. Patent Publication No. 2005-162445, entitled “Method and System for Interactive Cropping of a Graphical Object within a Containing Region” by Sheasby, Michael Chilton et al., U.S. Patent Publication No. 2002-191861, entitled “Automated Cropping of Electronic Images”. by Cheatle, Stephen Philip, and U.S. Patent Publication No. 2003-113035, entitled “Method and System for Compositing Images to Produce a Cropped Image” by Cahill, Nathan D. et al. disclose techniques for solving those problems. U.S. Patent Publication No. 2005-162445 discloses a technique for cropping a containing region from the original image according to user input. U.S. Patent Publication No. 2002-191861 discloses a technique for extracting an important region by merging regions having similar colors and automatically or semi-automatically cropping the extracted important region. U.S. Patent Publication No. 2003-113035 discloses a technique for cropping a picture having the largest size by excluding a concave-concavo portion of a peripheral area at a given aspect ratio when composing a large picture using a plurality of pictures that partially overlap with one another.

However, since such conventional techniques are limited to cropping a containing region, when a plurality of containing regions, i.e., regions of interest, are all cropped from a single frame image including a plurality of containing regions, watching quality still degrades. Moreover, when the size of an image is mechanically adjusted to fit into the small screen of a mobile device, a user cannot distinguish a small letter like a score when watching a sports moving picture due to non-consideration of the configuration of contents or detailed information. Furthermore, since editing formats of frame images forming contents are confined to editing formats provided by a contents providing device such as a broadcasting station, the user cannot watch contents in an edited format desired by the user.

### SUMMARY OF THE INVENTION

The present invention provides an image editing apparatus and method to generate an edited frame image by composing a plurality of containing regions that are extracted from a single frame image, and a recording medium having recorded thereon a program for implementing the image editing method.

According to one aspect of the present invention, there is provided an image editing apparatus. The image editing apparatus includes a containing region determination unit determining a plurality of containing regions from a frame image transmitted from a contents providing device based on first mapping information that maps a plurality of containing regions corresponding to a contents genre, a storage unit storing the a plurality of containing regions determined by the containing region determination unit, and a containing region composition unit reading a main containing region and a sub containing region that are determined from among the a plurality of containing regions determined by the containing region determination unit from the storage unit, composing the read main containing region and sub containing region, and providing an edited frame image resulting from the composition result.

According to another aspect of the present invention, there is provided an image editing method including extracting a plurality of containing regions from a frame image, determining a main containing region and a sub containing region from among the extracted containing regions and cropping a square area including the main containing region from the frame image, adjusting the size of the cropped. square area, and composing the size-adjusted square area and the sub containing region, thereby generating an edited frame image.

According to another aspect of the present invention, there is provided a computer-readable recording medium having recorded thereon a program for implementing the image editing method.

### BRIEF DESCRIPTION OF THE DRAWINGS

The above and other features and advantages of the present invention will become more apparent by describing in detail exemplary embodiments thereof with reference to the attached drawings in which:

FIG. 1 is a block diagram of a mobile communication system using an image editing apparatus according to the present invention;

FIG. 2 is a view for explaining an image editing method according to an exemplary embodiment of the present invention;

FIG. 3 is a block diagram of an image editing apparatus according to an exemplary embodiment of the present invention;

FIG. 4 is a detailed block diagram of an image input unit illustrated in FIG. 3;

FIG. 5 is a detailed block diagram of a containing region determination unit illustrated in FIG. 3;

FIG. 6 is a detailed block diagram of a shot feature analysis unit illustrated in FIG. 4 according to a first exemplary-embodiment of the present invention;

FIG. 7 is a, detailed block diagram of a shot feature analysis unit illustrated in FIG. 4 according to a second exemplary embodiment of the present invention;

FIG. 8 is a detailed block diagram of a shot feature analysis unit illustrated in FIG. 4 according to a third exemplary embodiment of the present. invention;

FIG. 9 is a detailed block diagram of a shot feature analysis unit illustrated in FIG. 4 according to a fourth exemplary embodiment of the present invention; and

FIG. 10 is a detailed block diagram of a containing region composition unit illustrated in FIG. 3.

### DETAILED DESCRIPTION OF THE INVENTION

Hereinafter, exemplary embodiments of the present invention will be described in detail with reference to the accompanying drawings.

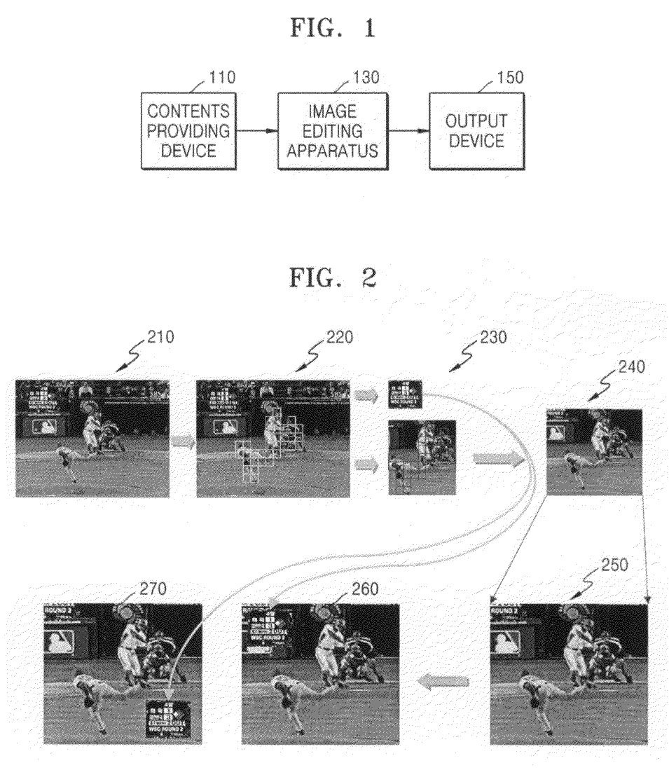

FIG. 1 is a block diagram of a mobile communication system using an image editing apparatus according to the present invention. The mobile communication system includes a contents providing device 110, an image editing apparatus 130, and an output device 150.

Referring to FIG. 1, the contents providing device 110 provides contents such as a sports moving picture or a news moving picture in units of frame images to the image editing apparatus 130. The contents providing device 110 may be a broadcasting station that provides moving pictures in real time or a server having a storage medium for previously storing a specific amount of moving pictures received from a broadcasting station.

For each of frame images forming contents provided from the contents provider 130, the image editing apparatus 130 extracts a plurality of containing regions, generates an edited frame image by composing the extracted containing regions, and outputs the generated edited frame image to the output device 150. For a frame image having no containing region, the image editing apparatus 130 directly outputs the frame image to the output device. 150 without processing the frame image. The image editing apparatus 130 may independently exist between the contents providing device 110 and the output device 150 or may be included in the contents providing device 110. When the output device 150 has embedded therein a high-definition (HD) tuner (not shown) capable of receiving an image whose resolution is equivalent to a HD level, the image editing apparatus 130 may be included in the output device 150.

The output device 150 displays the edited frame image or the original frame image that is provided from the image editing apparatus 130. The output device 150 may be any type of mobile devices capable of performing mobile communication, such as a cellular phone, a personal digital assistant (PDA), a portable multimedia player (PMP), and a play station portable (PSP).

FIG. 2 is a view for explaining an image editing method according to an exemplary embodiment of the present invention.

Referring to FIG. 2, contents provided from the contents providing device 110 are input in units of frame images in operation 210.

In operation 220, a plurality of containing regions are extracted from the input frame image. The containing regions are previously set for each contents genre in the image editing apparatus 130. When a call is established between the contents providing device.110 and the output device 150, genre information of contents to be provided by the contents providing device 110 is provided to the output device 150 through mobile communication between the contents providing device 110 and the output device 150, information about a desired containing region is provided from the output device 150 to the contents providing device 130 in response to the genre information, and information about a containing region selected by a user is provided from the contents providing device 130 to the image editing apparatus 150. To this end, it is preferable that the output device 150 previously stores a desired containing region for each contents genre. The containing region selected by the user for each contents genre may also be provided from the output device 150 to the image editing apparatus 130 through call establishment and mobile communication between the image editing apparatus 130 and the output device 150, instead of the contents providing device 110 and the output device 150.

In operation 230, containing regions to be composed are selected from among the containing regions that are extracted in operation 220. To this end, the image editing apparatus 130 previously stores containing regions to be composed for each shot feature. At this time, it is preferable that the image editing apparatus 130 stores a main containing region and at least one sub containing region corresponding thereto. Here, the shot feature means a predefined shot type for each contents genre. For example, the shot type may be a pitching shot in which a pitcher throws a ball in a baseball game or a penalty area shot in a soccer game. The position of a containing region varies with a shot type. When the output device 150 provides information about a desired containing region for each contents genre to the contents providing device 110 or the image editing apparatus 130, it is preferable that the output device 150 provide information about a main containing region and a sub containing region for each shot feature. When there are a plurality of sub containing regions corresponding to a main containing region, it is desirable to give different priorities to the sub containing regions.

In operation 240, a main containing region is selected from the containing regions selected in operation 230 and a square area including the main containing region is cropped from the input frame image. At this time, it is desirable to crop the square area at an aspect ratio of the screen of the output device 150.

In operation 250, the size of the square area that is cropped in operation 240 is adjusted according to the resolution of the output device 150. Here, the resolution may be previously set by default in the image editing apparatus 130. When a call is established between the contents providing device 110 and the output device 150, the output device 150 provides information about its resolution or acceptable size for the main containing region to the contents providing device 110 through mobile communication between the contents providing device 110 and the output device 150, and the contents providing device 110 provides the information to the image editing apparatus 130. The output device 150 may also provide the information about its resolution or acceptable size for the main containing region directly to the image editing apparatus 130 through call establishment and mobile communication between the image editing apparatus 130 and the output device 150, instead of the contents providing device 110 and the output device 150.

In operation 260 or 270, the at least one sub containing region is composed to a portion of the size-adjusted square area except for the main containing region, e.g., an upper left portion or a lower right potion of the size-adjusted square area, thereby generating an edited frame image. The sub containing regions may be positioned in a portion that is previously set by default in the size-adjusted square area or a portion having the largest size among portions except for the main containing region. When a plurality of sub containing regions are to be composed to a main containing region, each of them may be positioned in a portion having a size that is proportional to its priority. In other words, the sub containing region given a higher priority is positioned in a portion having a larger size. The size of each of the sub containing regions to be composed may be previously set by default or may be determined according to an area having the largest size among areas except for the main containing region. During call establishment between the contents providing device 110 or the image editing apparatus 130 and the output device 150, size information for the sub containing regions may be received from the output device 150.

If only one containing region is extracted in operation 220, operation 230, operation 260, or operation 270 may be skipped and the extracted containing region is selected as a main containing region and then operation 240 and operation 250 are performed.

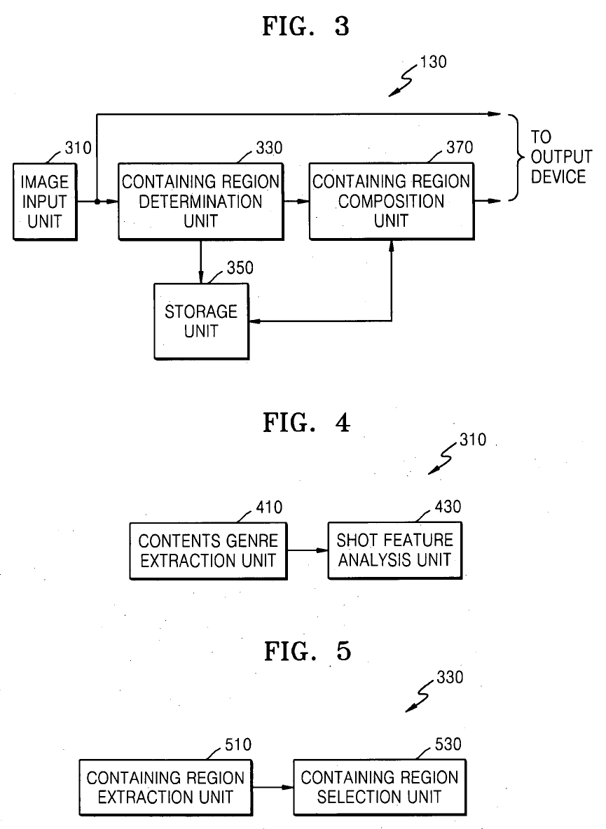

FIG. 3 is a block diagram of the image editing apparatus 130 according to an exemplary embodiment of the present invention. Referring to FIG. 3, the image editing apparatus 130 includes an image input unit 310, a containing region determination unit 330, a storage unit 350, and a containing region composition unit 370.

The image input unit 310 analyzes edge information and color information of an input frame image to determine whether the input frame image includes a shot feature for each contents genre and provides the frame image to the containing region determination unit 330 if it is determined that the input frame image includes a shot feature. If it is determined that the input frame image does not include a shot feature, the input frame image is provided to the output device (150 of FIG. 1). When a frame image is provided directly to the containing region determination unit 330 or the contents providing device (110 of FIG. 10) extracts a key frame from a frame image and provides the key frame to the image editing apparatus (130 of FIG. 1), the image input unit 310 may not be included in the image editing apparatus 130. Here, the frame image including a shot feature indicates a frame image including a containing region set by the image editing apparatus 130 or a user, i.e., including useful information. Preferably, a plurality of shot features for each contents genre and edge information and color information corresponding to the shot features are previously learned and stored in the image input unit 310.

The containing region determination unit 330 maps and stores a plurality of containing regions corresponding to shot features for each contents genre, containing regions to be composed out of a plurality of containing regions, a main containing region, and at least one sub containing region, extracts a plurality of containing regions from the input frame image based on mapping information, determines containing regions to be composed from among the extracted containing regions, and determines a main containing region and sub containing regions out of the containing regions to be composed. For example, when a shot feature for each contents genre is a shot in which a batter hits a ball in a baseball game, containing regions in a single frame image may include a pitcher region, a batter region, a catcher region, and a scoreboard region and containing regions to be composed may include the pitcher region, the batter region, and the catcher region or the pitcher region, the batter region, the catcher region, and the scoreboard region. Among the containing regions to be composed, the pitcher region, the batter region, and the catcher region are included in a main containing region and the scoreboard region is included in a sub containing region. The pitcher region, the batter region, and the catcher region among the containing regions can be detected using a model of each character that is previously learned with respect to the other regions except for field colors and the scoreboard region can be detected using vertical edge information. When only a main containing region exists as a containing region to be composed, the containing region determination unit 330 provides information indicating this case to the containing region composition unit 370.

When the contents providing device 110 or the image editing apparatus 130 transmits contents genre information to the output device 150 and the output device 150 receives information about a containing region for each contents genre and determines containing regions including a main containing region and sub containing regions, a user adaptive mobile video watching environment can be implemented.

The storing unit 350 temporarily stores a plurality of containing regions determined by the containing region determination unit 330.

The containing region composition unit 370 composes the size-adjusted at least one sub containing region with a square area including the size-adjusted main containing region out of the determined containing regions and outputs an edited frame image resulting from the composition to the output device 150. When the containing region composition unit 370 receives the information indicating that only a main containing region exists as a containing region to be composed from the containing region determination unit 330, the containing region composition unit 370 provides a square area including the size-adjusted main containing region to the output device 150.

According to another exemplary embodiment of the present invention, the containing region composition unit 370 may set the resolutions of a main containing region and sub containing regions included in a square area higher than the resolution of the other regions.

FIG. 4 is a detailed block diagram of the image input unit 310 illustrated in FIG. 3. Referring to FIG. 4, the image input unit 310 includes a contents genre extraction unit 410 and a shot feature analysis unit 430.

The contents genre extraction unit 410 analyzes electronic program guide (EPG) data included in contents or transmitted through a network to determine a contents genre. The contents genre may be, but not limited to, soccer, baseball, golf, volleyball, or news. The EPG data may be transmitted using various techniques that are well known to those skilled in the art.

The shot feature analysis unit 430 maps a plurality of shot features for each contents genre, determines whether an input frame image includes a shot feature, and provides the input frame image to the containing region determination unit 330 if it is determined that the input frame image includes a shot feature. When the frame image does not include a shot feature, the shot feature analysis unit 430 provides the frame image to the output device 150. Here, the shot feature is defined using previously learned edge information and color information of a frame image. A shot means a single frame image when the contents providing device 110 provides a moving picture in real time, and a shot means a plurality of frame images having no scene change when the contents providing device 110 provides a previously stored moving picture. When a shot means a plurality of frame images, a frame image having a sharp change from its previous or following frame image is detected and the shot is determined using the detected frame image as a boundary. Various techniques that are well known to those skilled in the art may be used for determination of a shot.

FIG. 5 is a detailed block diagram of the containing region determination unit 330 illustrated in FIG. 3. Referring to FIG. 5, the containing region determination unit 330 includes a containing region extraction unit 510 and a containing region selection unit 530.

The containing region extraction unit 510 maps containing regions corresponding to each contents genre and extracts a plurality of containing regions from the input frame image. At this time, various containing region extraction algorithms may be applied according to containing regions included in each shot feature that is defined for each content genre. For example, since a scoreboard region includes letters, it has a high vertical edge value due to the nature of letters. Thus, when the scoreboard region is detected, vertical edge information of an input frame image is extracted to be compared with a predetermined threshold and the scoreboard region is extracted according to the comparison result. The scoreboard region can also be extracted using a technique disclosed in the paper entitled “Event Detection in Field Sports Video Using Audio Visual Features and Support Vector Machine” by David A. Sadlier, Noel E. O'Connor in IEEE TRANSCATIONS ON CIRCUITS AND SYSTEMS FOR VIDEO TECHNOLOTY, Vol. 15, No. 10, October 2005. When a containing region corresponds to a character, it may be extracted using a previously learned basic model for each character. When a containing region corresponds to a ball, it may be extracted using a previously learned basic model for the ball. As such, a containing region extraction algorithm may be a learning-based algorithm using statistics or rules that are well known to those skilled in the art.

The containing region selection unit 530 defines containing regions to be composed out of a plurality of containing regions extracted from a single frame image and selects containing regions to be composed out of a plurality of containing regions extracted by the containing region extraction unit 510 based on mapping information. Here, the containing regions to be composed may include a main containing region and at least one sub containing region.

Containing regions that can be extracted for each contents genre by the containing region extraction unit 510 may be as shown in Table 1. Although not shown, each containing region may be matched to each shot feature for each contents genre.

TABLE 1

| Contents | | | | | |
|---|---|---|---|---|---|
| genre | Soccer | Baseball | Golf | Volleyball | News |
| Containing | Scoreboard | Scoreboard | Scoreboard | Scoreboard | Shoulder to |
| region | region | region | region | region | shoulder |
| | Penalty region | Player | Near hole | Near net | Image |
| | | close-up | | | |
| | | region | | | |
| | Player | Ball | Player | Player | Text region |
| | close-up | close-up | close-up | close-up | |
| | region | region | region | region | |
| | Ball | | Ball | | |
| | Close-up | | close-up | | |
| | region | | region | | |
| Removable | Auditorium | Auditorium | Spectators | Auditorium | Anchorman/ |
| region | | including no | | | Anchorwoman |
| | | ball | | | |
| | Field region | Field region | Field region | Field region | |
| | including no | including no | including no | including no | |
| | player or ball | player or ball | player or ball | player or ball | |

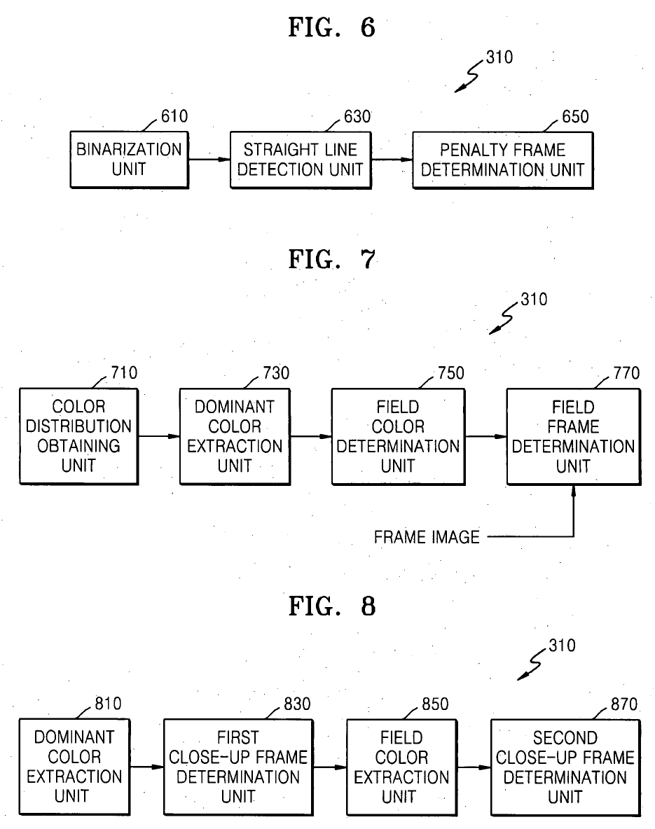

FIG. 6 is a detailed block diagram of the shot feature analysis unit 430 for determining a penalty frame when a contents genre is soccer, according to a first exemplary embodiment of the present invention. The shot feature analysis unit 430 includes a binarization unit 610, a straight line region detection unit 630, and a penalty frame determination unit 650.

Referring to FIG. 6, the binarization unit 610 performs binarization on the input frame image to output a binarized image. For example, the binarization may be performed as below.

First, the input frame image is divided into N×N blocks (e.g., N is 16) and determines a threshold T for brightness Y for each block as follows:

$$T = \frac{( {\sum }_{i = 0}^{N \times N} Y ( i ) )}{N \times N} \times a , \qquad ( 1 )$$

where a is a brightness threshold constant of e.g., 1.2.

Next, the brightness of a pixel included in each block is compared with a threshold for each block and a binarized image is generated by assigning 255 to a pixel if the brightness of the pixel is greater than the threshold for each block and 0 to the pixel if the brightness of the pixel is less than the threshold for each block.

The straight line region detection unit 630 extracts a white region assigned 0 from the binarized image provided by the binarization unit 610 and then performs, e.g., a Hough transform, on the extracted white region, thereby detecting a straight line region. According to Equation 1, the white region may be composed of pixels having brightness values that are greater than 1.2 times the average brightness value of the image. Using the Hough transform, a region in which the number of points, each two of which form lines having the same gradient by being connected to each other, is greater than a predetermined value is detected as the straight line region.

The penalty frame determination unit 650 determines whether the input frame image is a penalty frame using the straight line region detected by the straight line detection unit 630. In general, since the gradient of a straight line in a field region is different from that of a straight line in the penalty region, it is determined whether the input frame image is the penalty frame using the gradient of a straight line corresponding to a penalty line.

FIG. 7 is a detailed block diagram of the shot feature analysis unit 430 for determining a field frame when a contents genre is baseball, according to a second exemplary embodiment of the present invention. Referring to FIG. 7, the shot feature analysis unit 430 includes a color distribution obtaining unit 710, a dominant color extraction unit 730, a field color, determination unit 750, and a field frame determination unit 770.

When the input frame image is a play start scene, the color distribution obtaining unit 710 divides an input frame image into an upper half image and a lower half image and obtains color distribution in the lower half image. When the input frame image is not the play start scene, the size of the input frame image can be reduced by, replacing a pixel, e.g., the first pixel, a pixel having an average brightness value, or a pixel having the largest brightness value, with four pixels. In this way, by dividing the frame image into two halves or reducing the size of the frame, image to 1/4 of the original size, the amount of computation and the time required for filed color detection can be reduced. Here, it is preferable that color distribution be the HSV color distribution of each pixel.

The dominant color extraction unit 730 extracts a dominant color having the largest distribution range in the color distribution obtained by the color distribution obtaining unit 710.

The field color determination unit 750 determines the dominant color extracted by the dominant color extraction unit 730 and colors within a predetermined range that is adjacent to the dominant color as field colors.

The field frame determination unit 770 calculates a rate of the field colors determined in the field colors determination unit 750 in the input frame image and determines that the input frame is a field frame when the calculated rate is greater than a threshold.

FIG. 8 is a detailed block diagram of the shot feature analysis unit 430 for determining a close-up frame when a contents genre is soccer, according to a third exemplary embodiment of the present invention. Referring to FIG. 8, the shot feature analysis unit 430 includes a dominant color extraction unit 810, a first close-up frame determination unit 830, a field color extraction unit 850, and a second close-up frame determination unit 870.

The dominant color extraction unit 810 extracts a color having distribution that is greater than a predetermined threshold among the color distributions obtained from the input frame image as a dominant color.

The first close-up frame determination unit 830 compares the dominant color extracted from the dominant color extraction unit 810 with a previously learned and modeled field color. If a difference between the dominant color and the previously learned and modeled field color is greater than a predetermined threshold, it means that the extracted dominant color does not correspond to the field color and thus the input frame image is determined as a close-up frame.

If a difference between the dominant color and the previously learned and modeled field color is less than or equal to the predetermined threshold, the field color extraction unit 850 extracts the dominant color as a field color.

The second close-up frame determination unit 870 receives the field color extracted by the field color extraction unit 850, calculates the rate of the field color in each space window while scanning the input frame image by the space window unit, and determines the input frame image as a close-up frame when there is at least one space window in which the calculated rate is less than the threshold. At this time, the current space window moves from a lower left portion to a right portion in the frame image while partially overlapping with a previous space window.

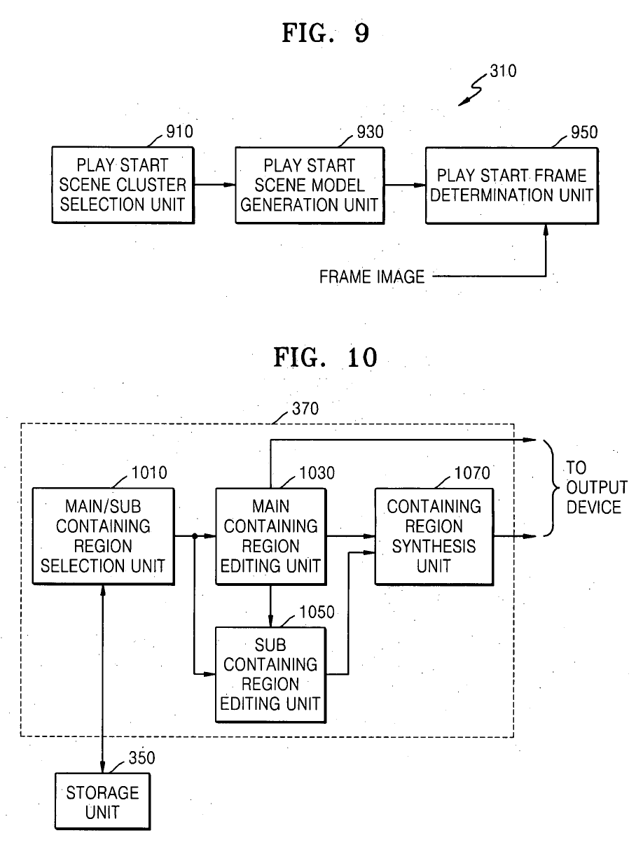

FIG. 9 is a detailed block diagram of the shot feature analysis unit 430 for determining a play start frame when a contents genre is baseball, according to a fourth exemplary embodiment of the present invention. Referring to FIG. 9, the shot feature analysis unit 430 includes a play start scene cluster selection unit 910, a play start scene model generation unit 930, and a play start frame determination unit 950. Here, when the contents providing device 110 provides a frame image in real time, the play start frame determination unit 950 previously stores a previously learned play start scene model without a need for the play start scene cluster selection unit 910 and the play start scene model selection unit 930.

Key frames of a plurality of previously input frame images are classified as a plurality of clusters. The play start scene cluster selection unit 910 selects a cluster including key frames corresponding to a play start scene in which a play period starts. The same shape or color is repeated over the key frames corresponding to the play start scene. Thus, the play start scene cluster selection unit 910 selects key frames corresponding to the play start scene based on the repetition characteristic of edge information and color information over the key frames corresponding to the play start scene. At this time, the play start scene cluster selection unit 910 calculates similarities between edge information and color information of key frames corresponding to the play start scene, and determines the key frames as key frames corresponding to the play start scene if the calculated similarities are greater than a predetermined threshold.

The play start scene model generation unit 930 generates a play start scene model using the key frames corresponding to the play start scene, which are selected by the play start scene cluster selection unit 910.

The play start frame determination unit 950 determines whether the input frame image is a play start frame using the play start scene model generated by the play start scene generation unit 930.

The shot feature analysis unit 430 can also be implemented variously according to each shot feature. The shot feature analysis unit 430 may store previously set basic model and variance range thereof for each contents genre and determine whether an input frame image includes a shot feature by matching the previously set basic model and variance range with the input frame image.

FIG. 10 is a detailed block diagram of the containing region composition unit 370 illustrated in FIG. 3. Referring to FIG. 10, the containing region composition unit 370 includes a main/sub containing region selection unit 1010, a main containing region editing unit 1030, a sub containing region editing unit 1050, and a containing region synthesis unit 1070.

The main/sub containing region selection unit 1010,selects and reads a main containing region and a sub containing region from among the determined plurality of containing regions from the storage unit 350 based on mapping information that maps a main containing region and a sub containing region according to a shot feature for each contents genre. The selected main containing region and sub containing region are provided to the main containing region editing unit 1030 and the sub containing region editing unit 1050, respectively.

The main containing region editing unit 1030 crops a square area including the selected main containing region from the input frame image and adjusts the size of the cropped square area according to the resolution of the output device 150. The resolution of the output device 150 may be previously set by default or be provided from the output device 150 through communication between the contents providing device 110 or the image editing apparatus 130 and the output device 150. When only one containing region is extracted from a single frame image, the containing region is selected as a main containing region and then edited and the edited main containing region is provided directly to the output device 150.

The sub containing region editing unit 1050 determines the size and position of the selected sub containing region in the square area provided from the main containing region editing unit 1030 and edits the sub containing region according to the determined size and position. The size and position of the sub containing region may be set by default, or the remaining areas except for the main containing region in the square area are obtained and then the size and position of the sub containing region may be determined according to the largest area among the obtained remaining areas.

The containing region synthesis unit 1070 synthesizes the main containing region edited by the main containing region editing unit 1030 and the sub containing region edited by the sub containing region editing unit 1050 and provides an edited frame image obtained from the composition to the output device 150.

The image editing apparatus according to the present invention may be implemented with an image editing algorithm according to a sequential signal processing flow. The implemented image editing algorithm may be installed in a control unit (not shown) included in the contents providing device 110 or the output device 150 or included in a separate server (not shown).

The thresholds used according to the present invention can be set to the optimal values based on simulation or experiment.

Meanwhile, the present invention can also be embodied as a computer-readable code on a computer-readable recording medium. The computer-readable recording medium is any data storage device that can store data which can be thereafter read by a computer system. Examples of computer-readable recording media include read-only memory (ROM), random-access memory (RAM), CD-ROMs, magnetic tapes, floppy disks, optical data storage devices, and carrier waves. The computer-readable recording medium can also be distributed over network of coupled computer systems so that the computer-readable code is stored and executed in a decentralized fashion. Functional programs, code, and code segments for implementing the present invention can be easily construed by programmers skilled in the art.

As described above, according to the present invention, it is possible to prevent degradation in watching quality with respect to a frame image including a containing region in a moving picture displayed on a mobile device. In particular, when a frame image includes a plurality of containing regions and a containing region associated with detailed information like letters in a mobile device in which a form factor is small, a user can easily recognize the detailed information during watching.

Moreover, a containing region, or a main containing region and a sub containing region can be set by the user, thereby maximizing user's utilization of contents.

Furthermore, since generation of separate contents for mobile environments can be partially automated in terms of one source multi use, the cost required for generating contents can be reduced.

Additionally, when an HD tuner is embedded in a mobile device, the user can effectively watch HD-level contents as well as low-resolution DMB images using the mobile device and flexibly use a large amount of information.

While the present invention has been particularly shown and described with reference to exemplary embodiments thereof, it will be understood by those of ordinary skill in the art that various changes in form and detail may be made therein without departing from the spirit and scope of the present invention as defined by the following claims.

What is claimed is:

1. An image editing apparatus comprising:
a containing region determination unit determining a plurality of containing regions from a frame image transmitted from a contents providing device based on first mapping information that maps the containing regions corresponding to a contents genre;
a storage unit storing the containing regions determined by the containing region determination unit; and
a containing region composition unit reading a main containing region and a sub containing region that are selected from among the containing regions determined by the containing region determination unit from the storage unit, composing the read main containing region and sub containing region, and providing an edited frame image resulting from the composition.

2. The image editing apparatus of claim 1, being implemented on the contents providing device.

3. The image editing apparatus of claim 1, being implemented on the output device.

4. The image editing apparatus of claim 1, wherein the first mapping information is provided from the output device.

5. The image editing apparatus of claim 1, further comprising an image input unit analyzing the frame image transmitted from the contents providing device to determine whether the frame image includes a shot feature and providing the frame image to the containing region determination unit if the frame image includes the shot feature.

6. The image editing apparatus of claim 1, wherein the containing region determination unit comprises:
a containing region extraction unit extracting the containing regions from the frame image based on the first mapping information; and
a containing region selection unit selecting containing regions to be composed, which include the main containing region and the sub containing region, from among the extracted containing regions based on second mapping information that maps the main containing region and at least one sub containing region that are to be combined with the main containing region.

7. The image editing apparatus of claim 6, wherein the second mapping information is provided from the output device.

8. The image editing apparatus of claim 6, wherein the containing region extraction unit extracts each of the containing regions using a previously set basic model for each of the containing regions.

9. The image editing apparatus of claim 1, wherein the containing region composition unit sets the resolutions of the, main containing region and the sub containing region included in the edited frame image higher than the resolution of the remaining region.

10. The image editing apparatus of claim 1, wherein the containing region composition unit comprises:
a main/sub containing region selection unit selecting the main containing region and the sub containing region from among the containing regions determined. by the containing region determination unit and reading the main containing region and the sub containing region from the storage unit;
a main containing region editing unit cropping a square area including the main containing region selected from the frame image and adjusting the size of the cropped square area, thereby generating an edited main containing region;
a sub containing region editing unit editing the sub containing region according to size and position information for the selected sub containing region in the edited main containing region; and
a containing region composition unit composing the edited main containing region and the edited sub containing region and providing an edited frame image resulting from the composition to the output device.

11. The image editing apparatus of claim 10, wherein the resolution of the output device is previously set by default or is set by communication between the image editing apparatus or the contents providing device and the output device.

12. The image editing apparatus of claim 10, wherein the size and position information for the sub containing region is set by default, or the remaining areas except for the main containing region in the size-adjusted square area are calculated and the size and position information for the sub containing region is determined according to the largest area among the calculated remaining areas.

13. An image editing method comprising:
extracting a plurality of containing regions from a frame image;
determining a main containing region and a sub containing region from among the extracted containing regions and cropping a square area including the main containing region from the frame image;
adjusting the size of the cropped square area; and
composing the size-adjusted square area and the sub containing region, thereby generating an edited frame image.

14. The image editing method of claim 13, further comprising selecting containing regions to be composed from among the extracted containing regions and determining the selected containing regions as the main containing region and at least one sub containing region.

15. The image editing method of claim 13, wherein in the extraction of the containing regions, information about containing regions to be extracted for each contents genre is provided from an output device that receives the edited frame image.

16. The image editing method of claim 13, wherein the extraction of the containing regions comprises extracting each of the containing regions using a previously set basic model for each of: the containing regions.

17. The image editing method of claim 13, wherein in the cropping of the square area, information about the main containing region and the sub containing region is provided from an output device that receives the edited frame image.

18. The image editing method of claim 13, wherein the size of the cropped square area is adjusted according to a resolution that is previously set by default or is set by communication between a contents providing device or an image editing apparatus and an output device.

19. The image editing method of claim 13, wherein the composition of the containing regions comprises setting the resolutions of the main containing region and the sub containing region included in the edited frame image higher than the resolution of the remaining region of the edited frame image.

20. A computer-readable recording medium having recorded thereon a program for implementing the image editing method of claim 13.
